(19) United States
(12) Patent Application Publication
(10) Pub. No.: US 2024/0094433 A1
(43) Pub. Date: Mar. 21, 2024

(54) INTEGRATED AUTONOMOUS OPERATIONS FOR INJECTION-PRODUCTION ANALYSIS AND PARAMETER SELECTION

(71) Applicant: Schlumberger Technology Corporation, Sugar Land, TX (US)

(72) Inventors: Shripad Biniwale, Churchlands (AU); Sanjoy Kumar Khataniar, Abingdon (GB); Mohamed Osman Mahgoub Ahmed, Abingdon (GB)

(21) Appl. No.: 18/469,324

(22) Filed: Sep. 18, 2023

Related U.S. Application Data
(60) Provisional application No. 63/376,147, filed on Sep. 19, 2022.

(51) Int. Cl. G01V 99/00; E21B 47/06; E21B 47/10

(52) U.S. Cl. CPC G01V 99/005; E21B 47/06; E21B 47/10; E21B 2200/20

(57) ABSTRACT

An integrated autonomous operation system that holistically renders the operation in digital form at multiple scales, including reservoir, surface infrastructure, workflows, processes, and the real asset. The system provides an end-to-end digital twin connecting subsurface to production. A subsurface model identifies and monitors water-producing zones for strategic decisions. The models use intelligent AI to provide optimum water injection setpoints. The models provide data to systems that automatically control the chokes and valves to meet the setpoints, thus achieving fully integrated, autonomous operations.

### CROSS-REFERENCE TO RELATED APPLICATIONS

This application claims priority to U.S. Provisional Patent Application No. 63/376,147, filed on Sep. 19, 2022, entitled “Integrated Autonomous Operations for Injection-Production Analysis and Parameter Selection,” the entirety of which is incorporated by reference.

### BACKGROUND

Various techniques for evaluating options/plans in an oil and gas context and deciding upon parameters in a quantifiable way are available in the oil and gas industry. However, oilfield operations are often complex, and thus such evaluation/enhancement techniques are often provided for individual tasks, or even parts of tasks, within individual domain silos. Because of the complexity of the operations and limitations of fragmented technologies, integrated systems that achieve an autonomous solution remain a particular challenge to implement. Full-scale numerical modeling software and analytical modelling spreadsheets using real-time, digital monitoring, and data gathering are thus generally employed. Such solutions, however, do not provide an integrated automated system.

Challenges to achieving such autonomous operational processing include (1) lack of integration between various disciplines such as reservoir models, production systems, production facilities, and operations control, (2) siloed processing in which each domain selects parameters within its domain constraints, and lack of domain integration for operational decision-making, (3) lack of a feedback loop between tactical and operational tools causing operational decisions to be reactive than proactive, and (4) lack of automation and integration among, for example, production monitoring and reservoir models.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for autonomously performing a subsurface operation. The method also includes determining real-time data associated with the subsurface operation; building a first model based at least on the real-time data, where the first model includes a first set of elements, where the first set of elements includes a first subset of features from a design of the subsurface operation; calculating objectives for the subsurface operation using the first model; updating the first model based at least on the calculated objectives; setting operational setpoints based at least on the calculated objectives; managing production based at least upon the operational setpoints; building a second model based at least on the real-time data, where the second model includes a second set of elements, where the second set of elements includes a second subset of the features from the design of the subsurface operation, where the first set of elements is smaller than the second set of elements; adjusting pre-selected of the second set of elements to match historic data associated with the subsurface operation; optimizing the second set of elements for the subsurface operation; and determining a field development scenario associated with the subsurface operation based at least upon the second model. Other embodiments of this aspect include corresponding computer systems, apparatus, and computer programs recorded on one or more computer storage devices, each configured to perform the actions of the methods.

Implementations may include one or more of the following features. The method as may include: validating the first model, where the validating includes ensuring that the first model meets a threshold of performance. The method also may include: continuing to build the first model if the first model does not meet the threshold. The method also may include: calculating objectives for the subsurface operation using the first model if the first model meets the threshold. The method also may include: optimizing the calculated objectives for the subsurface operation. The method also may include: receiving electronic communications from devices associated with the subsurface operation. The electronic communications include real-time remote operation and asset information, the electronic communications include desired settings associated with the subsurface operation, the devices include edge and internet-of-things (IOT) devices, and the electronic communications are received by a platform processing data from the edge and IOT devices and from one or more processors. The method also may include: providing the operational setpoints to the platform as the desired settings. The method may include: designing a surface facility associated with the subsurface operation based at least upon the second model, and determining subsurface operation targets based at least upon the second model. The real-time data may include: pressures, virtual flowrates, and equipment status. Implementations of the described techniques may include hardware, a method or process, or computer software on a computer-accessible medium.

One general aspect includes a computing system for autonomously performing a subsurface operation. The computing system also includes one or more processors; and a memory system may include one or more non-transitory computer-readable media storing instructions that, when executed by at least one of the one or more processors, cause the computing system to perform operations, the operations may include: receiving electronic communications from devices associated with the subsurface operation; determining real-time data from the received electronic communications; building a first model based at least on the real-time data, where the first model includes a first set of elements, where the first set of elements includes a first subset of features from a design of the subsurface operation; validating the first model, where the validating includes ensuring that the first model meets a threshold of performance; calculating objectives for the subsurface operation using the first model if the first model meets the threshold; updating the first model based at least on the calculated objectives; setting operational setpoints based at least on the calculated objectives. The system also includes providing the operational setpoints to a platform as desired settings. The system also includes managing production based at least upon the operational setpoints; building a second model based at least on the real-time data, adjusting pre-selected of the second set of elements to match historic data associated with the subsurface operation, optimizing a second set of elements for the subsurface operation. The system also includes determining a field development scenario associated with the subsurface operation based at least upon the second model. Other embodiments of this aspect include corresponding computer systems, apparatus, and computer programs recorded on one or more computer storage devices, each configured to perform the actions of the methods. Implementations of the described techniques may include hardware, a method or process, or computer software on a computer-accessible medium. Another general aspect includes a non-transitory computer-readable medium storing instructions for autonomously performing a subsurface operation.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates an integrated autonomous operations analysis and parameter selection framework, according to an embodiment.

FIG. 3 illustrates an integrated autonomous operations use case for waterflood analysis and parameter selection, according to an embodiment.

FIGS. 4A, 4B, and 4C are flowcharts of an exemplary method in accordance with the present disclosure.

FIG. 5 illustrates a schematic view of a computing system, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

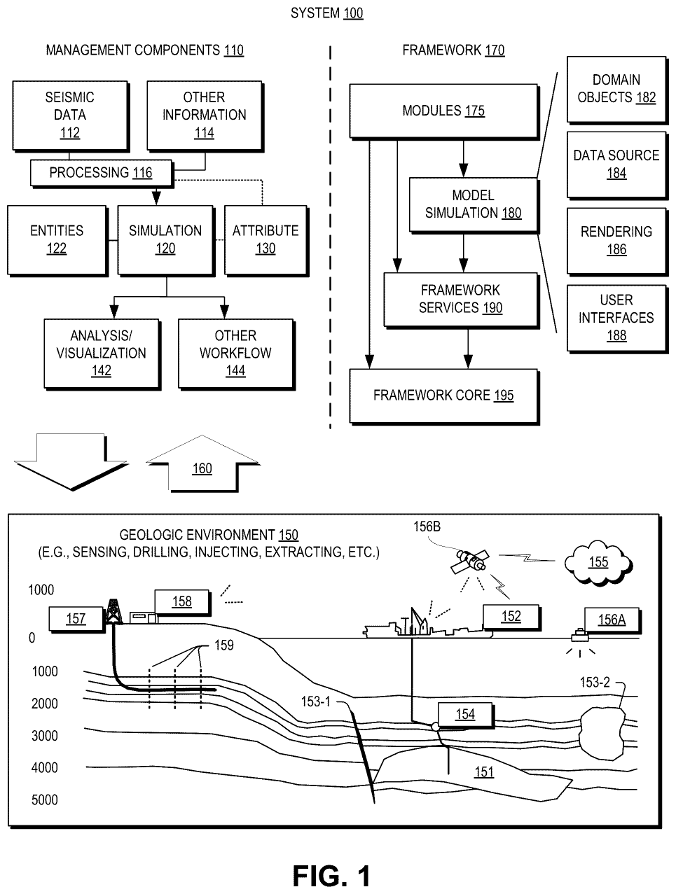

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Texas), the INTERSECT™ reservoir simulator (Schlumberger Limited, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

Embodiments of the disclosure may provide an integrated autonomous operation system, e.g., a system that holistically renders the operation in digital form at multiple scales, including reservoir, surface infrastructure, workflows, processes, and the real asset. Generally, the system provides an end-to-end digital twin connecting subsurface to production. The system uses a field development plan (FDP) model to define an analysis and enhancement plan within constraints and a subsurface model to identify and monitor water-producing zones for strategic decisions. The tactical system uses intelligent AI models to provide optimum water injection setpoints. In some embodiments, the models provide data to systems that automatically control the chokes and valves to meet the setpoints, thus achieving fully integrated, autonomous operations.

At least some embodiments may include a decision support system. The decision support system may, for example, integrate functionality from several different areas. Such areas may include, for example, asset management, surveillance and diagnostic, opportunity management, reservoir modeling, and field analysis and enhancement. The integration of these areas may create an autonomous system for injection-production parameter selection.

The decision support system is focused on injection-production parameter selection in tactical and operational decision space that can continuously monitor reservoir conditions and enhance injection into the required reservoir zones to enhance (e.g., increase) production. The system may leverage data-driven and artificial intelligence (AI) models that automatically calculate and provide new setpoints to control systems for chokes and valves or other equipment, e.g., creating automated closed loop operational feedback.

The system may include various workflows that encompass several tasks and creates smart, actionable insights to take automatic control of injection system to enhance production. Integrated autonomous injection-production balancing is a complex process that may call for integration of various domains. It can be applied in many secondary and tertiary recovery mechanisms such as water injection, gas injection, and chemical injection. The system may be used to improve the oil recovery. Such improvement may be accomplished by “voidage replacement”, which may refer to injection to maintain reservoir pressure at the desired operating level and/or by displacing hydrocarbons towards producing wells.

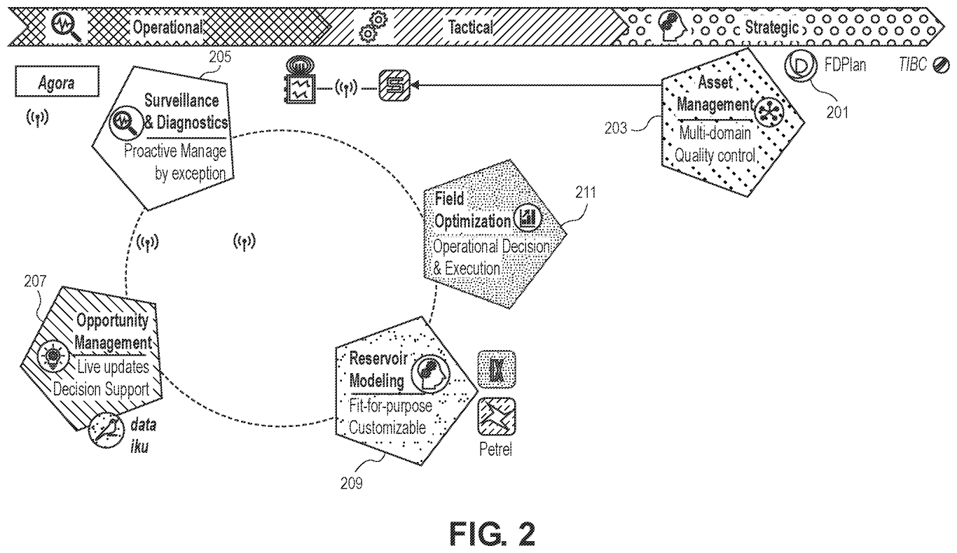

FIG. 2 illustrates an example of water injection, where multiple domain technologies have been incorporated to achieve integrated autonomous waterflood operations. However, the same concept can be applied in other injection scenarios such as gas, chemical and steam injection.

The system starts with a field development plan 201, where strategic decisions are defined, and techno-economic analysis is carried out for asset management decisions 203. Software platforms such as the AGORA® platform may be utilized for real-time data collection and proactive management of production based on the exception for surveillance and diagnostic decisions 205. This production data is fed to the database and is extracted by the DATAIKU® tool to perform data-driven diagnostics and hybrid data-physics-driven models for the opportunity management decisions 207.

The relevant-time production data can be fed to reservoir modeling tools 209 via an automatic model update tool (e.g., INTERSECT®, ECLIPSE®, and/or PETREL®) and is used for tactical decision-making. This combination of technologies (machine learning, hybrid, and potential failure mode analysis) has the potential to operate alongside numerical reservoir models 209 also using potential failure mode analysis and provide the best of both data-driven and model-driven methods for operations decision support and will be used for field enhancement decisions 211. The outcomes from this hybrid model, such as new setpoints and target injection rate, are passed to the AGORA® system to implement in the field operations. An edge/IOT system can be used to automatically control the chokes and valves to meet the setpoints thus achieving fully integrated, autonomous operations. The outcomes can be consumed by conventional field development plan systems to analyze new tactical and strategic development plans.

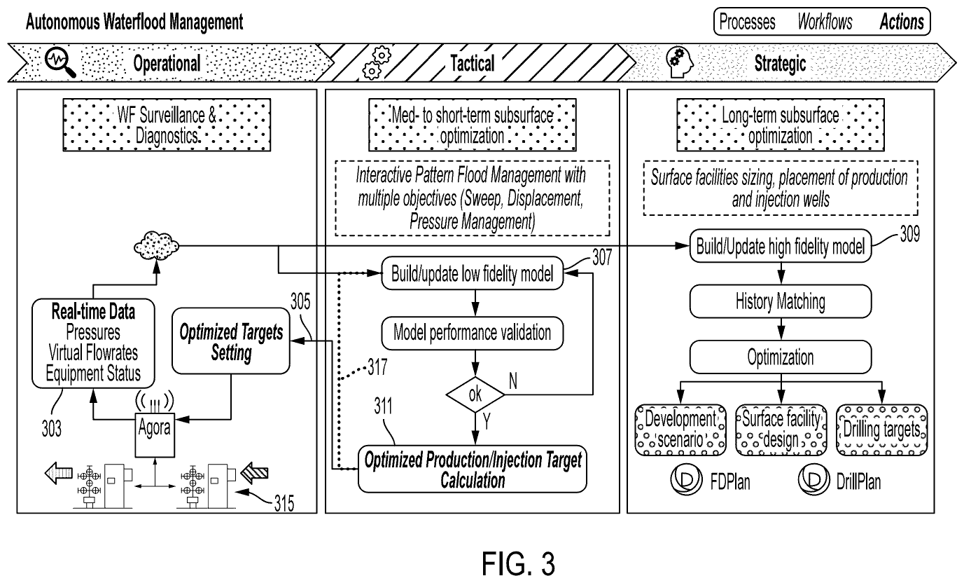

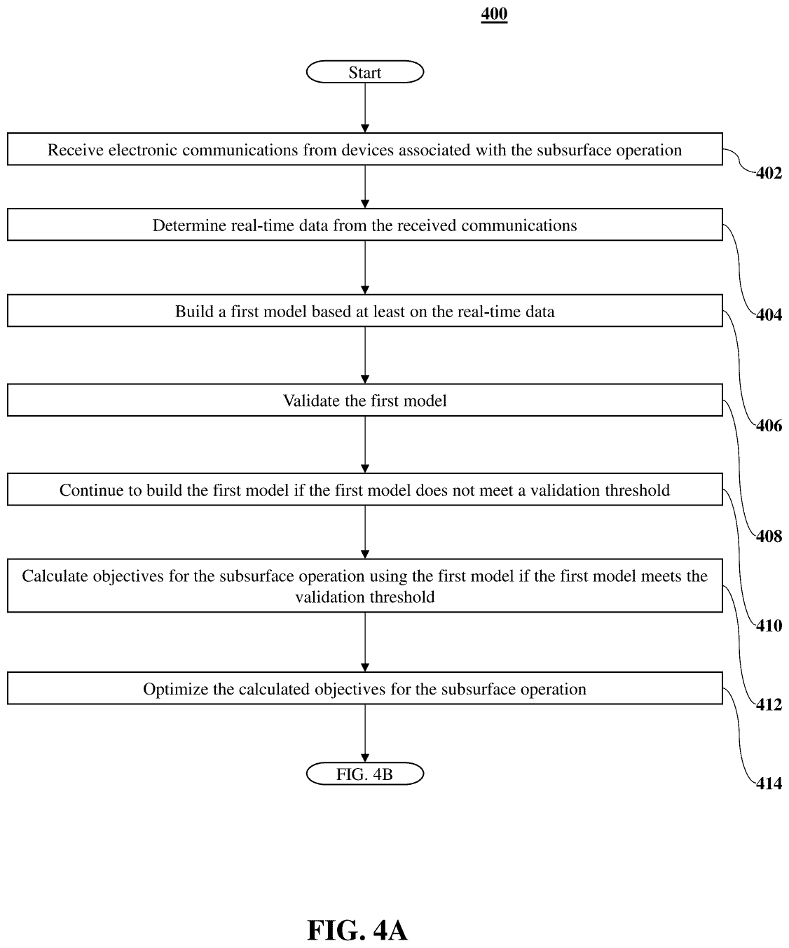

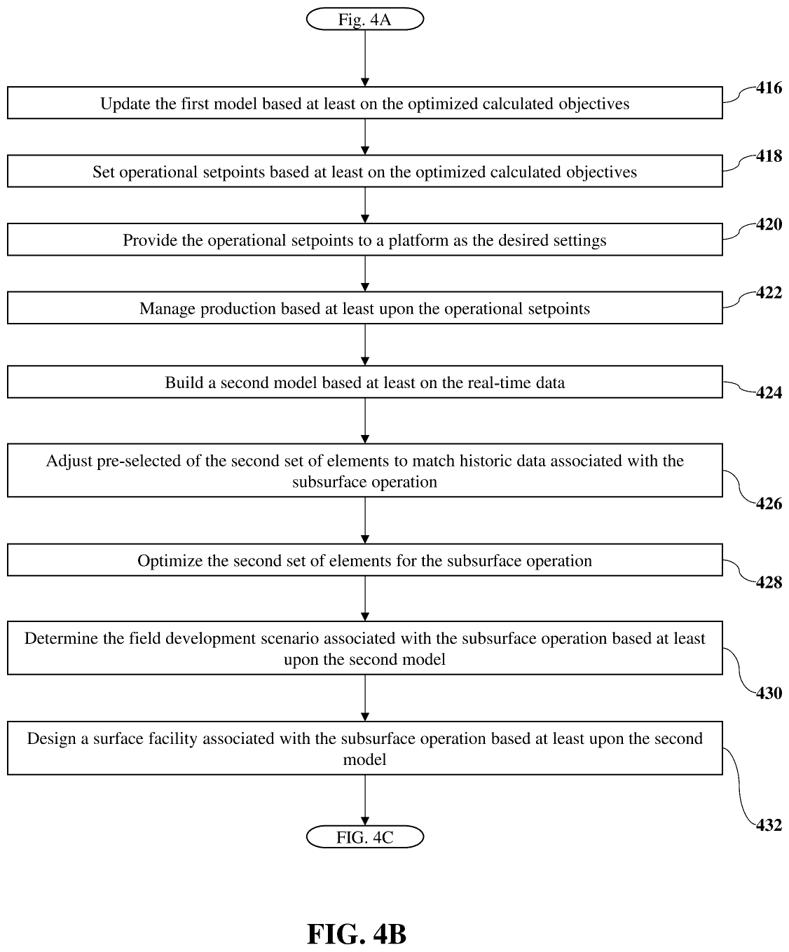

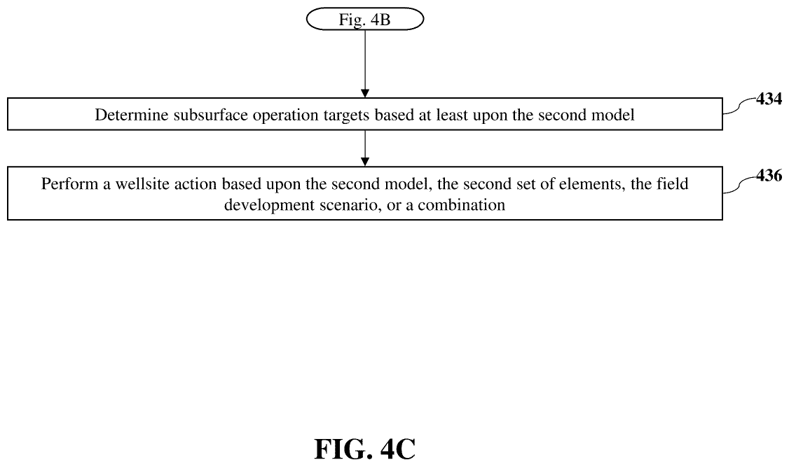

Referring now to FIG. 3, the logic of the autonomous waterflood management system includes processes, workflows, and advisory systems that operate over strategic, tactical, and operational decision space. The diagram also shows an automated closed loop operational feedback system 305 between operational and tactical decision space. It also highlights how strategic models and decision systems that play a crucial role in defining longer-term strategies can provide feedback to tactical decisions. A workflow showing the application of this method is shown in FIGS. 4A and 4B, according to an example.

In FIG. 3, production and/or injection data 303 from, for example, but not limited to, a database 315, and, with well-completion location information, are used to build and calibrate a machine learning-assisted hybrid model 307/309. Once the model is calibrated, it is ready for use in the workflow. Several conditions can trigger an update 305/317 of the model to achieve an increased reflection of real-world conditions as measured. Performance of the field and wells can be monitored, and set points can be found to enhance performance or recommend remedial operations. Decision support in this embodiment is enhanced by multi-domain integration, that is, an integrated approach to parameter analysis and selection as against a siloed approach, and provides automated insights for proactive operational response which provides an opportunity for fully autonomous operations.

FIGS. 4A and 4B illustrate a flowchart of a method 400 for autonomously performing a subsurface operation, according to an embodiment. An illustrative order of the method 400 is provided below; however, one or more portions of the method 400 may be performed in a different order, simultaneously, repeated or omitted.

The method 400 may include receiving electronic communications from devices associated with the subsurface operation, as at 402. The electronic communications may include real-time remote operation and asset information. The electronic communications may include desired settings associated with the subsurface operation. The devices may include edge and Internet-of-Things (IOT) devices. The electronic communications may be received by a platform processing data from the edge and the IOT devices and from one or more processors.

The method may also include determining real-time data from the received communications, as at 404. The real-time data may include pressures, virtual flowrates, equipment status, or a combination thereof.

The method 400 may also include building a first model based at least on the real-time data, as at 406. The first model may include a first set of elements. The first set of elements may include a first subset of features from a design of the subsurface operation. The design may include a field development scenario, a surface facility, subsurface operation targets, or a combination thereof.

The method 400 may also include validating the first model, as at 408. The validating may include ensuring that the first model meets a threshold of performance.

The method 400 may also include continuing to build the first model if the first model does not meet the threshold, as at 410.

The method 400 may also include calculating objectives for the subsurface operation using the first model if the first model meets the threshold, as at 412. The objectives may include production and/or injection targets.

The method 400 may also include optimizing the calculated objectives for the subsurface operation, as at 414.

The method 400 may also include updating the first model based at least on the optimized calculated objectives, as at 416.

The method 400 may also include setting operational setpoints based at least on the optimized calculated objectives, as at 418.

The method 400 may also include providing the operational setpoints to the platform as the desired settings, as at 420.

The method 400 may also include managing production based at least upon the operational setpoints, as at 422.

The method 400 may also include building a second model based at least on the real-time data, as at 424. The second model may include a second set of elements. The second set of elements may include a second subset of the features from the design of the subsurface operation. The first set of elements may be smaller than the second set of elements.

The method 400 may also include adjusting pre-selected of the second set of elements to match historic data associated with the subsurface operation, as at 426.

The method 400 may also include optimizing the second set of elements for the subsurface operation, as at 428.

The method 400 may also include determining the field development scenario associated with the subsurface operation based at least upon the second model, as at 430. The field development scenario may include numbers of assets, types of the assets, locations of the assets, levels of field production for the assets, results from appraisal well drilling, or a combination thereof. The determining may include performing a technical analysis of the subsurface operation and performing an economic analysis of the subsurface operation.

The method 400 may also include designing the surface facility associated with the subsurface operation based at least upon the second model, as at 432. The surface facility may include above-ground appurtenance, structures, equipment, storage fixtures, processing fixtures, or a combination thereof.

The method 400 may also include determining the subsurface operation targets based at least upon the second model, as at 434. The subsurface operation targets may include target categories, target positions, target shapes, target boundaries, target features associated with the subsurface operational targets, or a combination thereof. The target features may include target boreholes, the target categories, target coordinate systems, or a combination thereof.

The method 400 also includes performing a wellsite action, as at 436. The wellsite action may be performed based upon the second model, the (e.g., optimized) second set of elements, the field development scenario, or a combination thereof. The wellsite action may be or include generating and/or transmitting a signal (e.g., using a computing system) that causes a physical action to occur at a wellsite. The wellsite action may also or instead include performing the physical action at the wellsite. The physical action may be or include selecting where to drill a wellbore, drilling the wellbore, varying a weight and/or torque on a drill bit that drills the wellbore, varying a drilling trajectory of the wellbore, varying a concentration and/or flow rate of a fluid pumped into the wellbore, or the like.

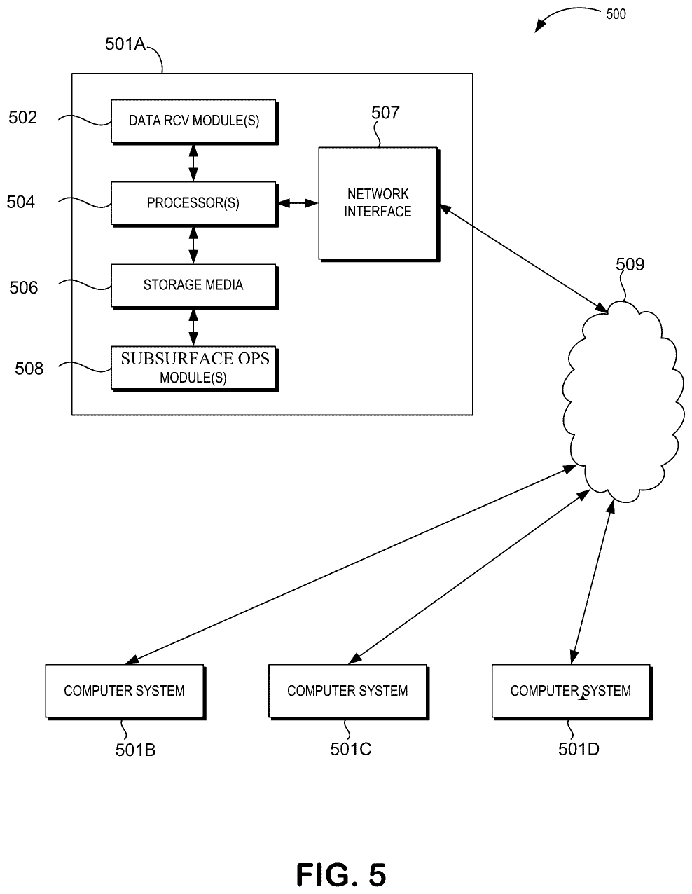

In some embodiments, the methods of the present disclosure may be executed by a computing system. FIG. 5 illustrates an example of such a computing system 500, in accordance with some embodiments. The computing system 500 may include a computer or computer system 501A, which may be an individual computer system 501A or an arrangement of distributed computer systems. The computer system 501A includes one or more data reception and processing modules 502 that are configured to perform various tasks according to some embodiments, such as one or more methods disclosed herein. To perform these various tasks, the data reception and processing module 502 executes independently, or in coordination with, one or more processors 504, which is (or are) connected to one or more storage media 506. The processor(s) 504 is (or are) also connected to a network interface 507 to allow the computer system 501A to communicate over a data network 509 with one or more additional computer systems and/or computing systems, such as 501B, 501C, and/or 501D (note that computer systems 501B, 501C and/or 501D may or may not share the same architecture as computer system 501A, and may be located in different physical locations, e.g., computer systems 501A and 501B may be located in a processing facility, while in communication with one or more computer systems such as 501C and/or 501D that are located in one or more data centers, and/or located in varying countries on different continents).

A processor may include a microprocessor, microcontroller, processor module or subsystem, programmable integrated circuit, programmable gate array, or another control or computing device.

The storage media 506 may be implemented as one or more computer-readable or machine-readable storage media. Note that while in the example embodiment of FIG. 5 storage media 506 is depicted as within computer system 501A, in some embodiments, storage media 506 may be distributed within and/or across multiple internal and/or external enclosures of computing system 501A and/or additional computing systems. Storage media 506 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 500 contains one or more subsurface operations module(s) 508. In the example of computing system 500, computer system 501A includes the subsurface operations module 508. In some embodiments, a single subsurface operations module may be used to perform some aspects of one or more embodiments of the methods disclosed herein. In other embodiments, a plurality of subsurface operations modules may be used to perform some aspects of methods herein.

It should be appreciated that computing system 500 is merely one example of a computing system, and that computing system 500 may have more or fewer components than shown, may combine additional components not depicted in the example embodiment of FIG. 5, and/or computing system 500 may have a different configuration or arrangement of the components depicted in FIG. 5. The various components shown in FIG. 5 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 500, FIG. 5), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated. In the claims that follow, for US patent applications, section 112 paragraph sixth is not invoked unless the phrase “means for” is used.

1. A method for autonomously performing a subsurface operation, the method comprising:
determining real-time data associated with the subsurface operation;
building a first model based at least on the real-time data, wherein the first model includes a first set of elements, wherein the first set of elements includes a first subset of features from a design of the subsurface operation;
calculating objectives for the subsurface operation using the first model;
setting operational setpoints based at least on the calculated objectives;
managing production based at least upon the operational setpoints;
building a second model based at least on the real-time data, wherein the second model includes a second set of elements, wherein the second set of elements includes a second subset of the features from the design of the subsurface operation, wherein the first set of elements is smaller than the second set of elements;
adjusting pre-selected of the second set of elements to match historic data associated with the subsurface operation;
optimizing the second set of elements for the subsurface operation; and
determining a field development scenario associated with the subsurface operation based at least upon the second model.

2. The method as in claim 1 further comprising:
validating the first model, wherein the validating includes ensuring that the first model meets a threshold of performance.

3. The method as in claim 2 further comprising:
continuing to build the first model if the first model does not meet the threshold.

4. The method as in claim 2 further comprising:
calculating objectives for the subsurface operation using the first model if the first model meets the threshold.

5. The method as in claim 4 further comprising:
optimizing the calculated objectives for the subsurface operation.

6. The method as in claim 1 further comprising:
receiving electronic communications from devices associated with the subsurface operation.

7. The method as in claim 6 wherein the electronic communications include real-time remote operation and asset information, the electronic communications include desired settings associated with the subsurface operation, the devices include edge and Internet-of-Things (IOT) devices, and the electronic communications are received by a platform processing data from the edge and IOT devices and from one or more processors.

8. The method as in claim 7 further comprising:
providing the operational setpoints to the platform as the desired settings.

9. The method in claim 1 further comprising:
designing a surface facility associated with the subsurface operation based at least upon the second model; and
determining subsurface operation targets based at least upon the second model.

10. The method as in claim 1 wherein the real-time data comprises:
pressures, virtual flowrates, and equipment status.

11. A computing system for autonomously performing a subsurface operation, the computing system comprising:
one or more processors; and
a memory system comprising one or more non-transitory computer-readable media storing instructions that, when executed by at least one of the one or more processors, cause the computing system to perform operations, the operations comprising:
receiving electronic communications from devices associated with the subsurface operation;
determining real-time data from the received electronic communications;
building a first model based at least on the real-time data, wherein the first model includes a first set of elements, wherein the first set of elements includes a first subset of features from a design of the subsurface operation;
validating the first model, wherein the validating includes ensuring that the first model meets a threshold of performance;
calculating objectives for the subsurface operation using the first model if the first model meets the threshold;
updating the first model based at least on the calculated objectives;
setting operational setpoints based at least on the calculated objectives;
providing the operational setpoints to a platform as desired settings;
managing production based at least upon the operational setpoints;
building a second model based at least on the real-time data;
adjusting pre-selected of the second set of elements to match historic data associated with the subsurface operation;
optimizing a second set of elements for the subsurface operation; and
determining a field development scenario associated with the subsurface operation based at least upon the second model.

12. The computing system as in claim 11 further comprising:
designing a surface facility associated with the subsurface operation based at least upon the second model; and
determining subsurface operation targets based at least upon the second model.

13. The computing system as in claim 11 wherein the electronic include real-time remote operation and asset information, the electronic communications include desired settings associated with the subsurface operation, the devices include edge and Internet-of-Things (IOT) devices, and the electronic communications are received by a platform processing data from the edge and the IOT devices and from the one or more processors.

14. The computing system as in claim 11 further comprising:
continuing to build the first model if the first model does not meet the threshold.

15. The computing system as in claim 11 further comprising:
optimizing the calculated objectives for the subsurface operation.

16. The computing system as in claim 11 wherein the real-time data comprises:
pressures, virtual flowrates, and equipment status.

17. The computing system as in claim 11 wherein the objectives comprise:
production and injection targets.

18. The computing system as in claim 11 wherein the second model comprises:
the second set of elements,
wherein the second set of elements includes a second subset of the features from the design of the subsurface operation, and
wherein the first set of elements is smaller than the second set of elements.

19. The computing system as in claim 12 wherein the surface facility comprises:
above-ground appurtenance, structures, equipment, storage fixtures, and processing fixture,
wherein subsurface operation targets include target categories, target positions, target shapes, target boundaries, and target features associated with the subsurface operational targets, and
wherein the target features include target boreholes, the target categories, and target coordinate systems.

20. A non-transitory computer-readable medium storing instructions for autonomously performing a subsurface operation that, when executed by one or more processors of a computing system, cause the computing system to perform operations, the operations comprising:
receiving electronic communications from devices associated with the subsurface operation, wherein the electronic communications include real-time remote operation and asset information, wherein the electronic communications include desired settings associated with the subsurface operation, wherein the devices include edge and Internet-of-Things (IOT) devices, wherein the electronic communications are received by a platform processing data from the edge and the IOT devices and from one or more processors;
determining real-time data from the received communications, wherein the real-time data includes pressures, virtual flowrates, and equipment status;
building a first model based at least on the real-time data, wherein the first model includes a first set of elements, wherein the first set of elements includes a first subset of features from a design of the subsurface operation, wherein the design includes a field development scenario, a surface facility, and subsurface operation targets;
validating the first model, wherein the validating includes ensuring that the first model meets a threshold of performance;
continuing to build the first model if the first model does not meet the threshold;
calculating objectives for the subsurface operation using the first model if the first model meets the threshold, wherein the objectives include production and injection targets;
optimizing the calculated objectives for the subsurface operation;
updating the first model based at least on the optimized calculated objectives;
setting operational setpoints based at least on the optimized calculated objectives;
providing the operational setpoints to the platform as the desired settings;
managing production based at least upon the operational setpoints;
building a second model based at least on the real-time data, wherein the second model includes a second set of elements, wherein the second set of elements includes a second subset of the features from the design of the subsurface operation, wherein the first set of elements is smaller than the second set of elements;
adjusting pre-selected of the second set of elements to match historic data associated with the subsurface operation;
optimizing the second set of elements for the subsurface operation;
determining the field development scenario associated with the subsurface operation based at least upon the second model, wherein the field development scenario includes numbers of assets, types of the assets, locations of the assets, levels of field production for the assets, and results from appraisal well drilling, wherein the determining includes performing a technical analysis of the subsurface operation and performing an economic analysis of the subsurface operation;
designing the surface facility associated with the subsurface operation based at least upon the second model, wherein the surface facility includes above-ground appurtenance, structures, equipment, storage fixtures, and processing fixtures; and
determining the subsurface operation targets based at least upon the second model, wherein the subsurface operation targets include target categories, target positions, target shapes, target boundaries, and target features associated with the subsurface operational targets, wherein the target features include target boreholes, the target categories, and target coordinate systems.
